(19) United States
(12) Patent Application Publication
(10) Pub. No.: US 2008/0088479 A1
(43) Pub. Date: Apr. 17, 2008

(54) Traffic light warning method and system

(75) Inventors: Lorenzo Caminiti, Ann Arbor, MI (US); Derek S. Caveney, Ann Arbor, MI (US); Kenneth P. Laberteaux, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Engineering & Manufacturing North America, Inc., Erlanger, KY (US)

(21) Appl. No.: 11/549,317

(22) Filed: Oct. 13, 2006

(51) Int. Cl. G08G 1/00; G08G 1/095

(52) U.S. Cl. 340/932; 340/907

(57) ABSTRACT

A traffic light warning system and method for an automotive vehicle. The system receives a signal from a traffic light representative of the geographical area, state and operation of the traffic light. The system then determines at least one time period in which the traffic light indicates a stop command. The position of the vehicle during that time period is then predicted as a function of the current traveling parameters of the vehicle and a warning signal is generated to the vehicle occupant whenever the predicted position of the vehicle is within the geographic area of the traffic light during the time period.

### BACKGROUND OF THE INVENTION

I. Field of the Invention

The present invention relates generally to a traffic light warning system and method for an automotive vehicle.

II. Description of Related Art

There are a number of previously known traffic light warning systems in which a signal is generated to an oncoming vehicle if it appears that the vehicle will enter the intersection during a red or stop traffic light condition. These previously known systems, however, have not proven entirely effective in use.

One disadvantage of these previously known systems is that such systems fail to account for the actual geographic area of the traffic light intersection. Since traffic light intersections vary in geographic size, these previously known systems are inherently inaccurate in operation.

A still further disadvantage of these previously known traffic light warning systems is that such systems merely use the position of a vehicle from the intersection and the instantaneous speed of the vehicle to determine whether or not a warning signal should be generated. As such, these previously known traffic light warning systems fail to accommodate for other vehicle dynamics, e.g. acceleration or deceleration of the vehicle, as well as other factors when determining whether or not the vehicle will enter the intersection during a red light condition.

A still further disadvantage of these previously known traffic light warning systems is that they fail to account for multiple and closely spaced traffic lights of the type that may be found within a city. As such, these previously known systems are somewhat limited in operation.

### SUMMARY OF THE PRESENT INVENTION

The present invention provides a traffic light warning system and method for an automotive vehicle which overcomes the above-mentioned disadvantages of the previously known methods and systems.

In brief, in the present invention the traffic light repeatedly generates a wireless or radio signal indicative of the geographic area, state and operation of the traffic light. More specifically, the geographic area could include the four corners of the intersection which will vary as a function of the size of the intersection. Furthermore, the geographic region of a particular traffic light signal could be some subregion of the entire intersection in order to pertain to a particular lane of traffic. The state of the traffic light includes its current condition, e.g. red, green or yellow, as well as the current time of the transmission. Lastly, the data transmitted from the traffic light regarding the operation of the traffic light includes the duration of the red, green and yellow lights as well as the time to the next phase transition,

The automotive vehicle includes a receiver which receives the signal from the traffic light and then determines at least one time period in which the traffic light indicates a stop command or red light. This time period will include both a time that the red light is initiated as well as the time that the red light is terminated relative to the transmission time of the signal from the traffic light. Furthermore, since only relatively near traffic lights are of interest to the vehicle, the time period during the red light signal condition will be used for further calculations only in the event that a portion of the time period is less than a threshold time period. This threshold time period, furthermore, may be either preset, or variably set as a function of the automotive vehicle speed.

A processor in the vehicle then predicts the position of the vehicle during the time period as a function of the position and path characteristics of the vehicle. These path characteristics of the vehicle include, inter alia, the instantaneous vehicle speed, acceleration or deceleration of the vehicle, the direction of the vehicle and the angle of the steering wheel.

Thereafter, a warning signal is generated within the vehicle whenever the predicted position of the vehicle is within the geographic area associated with a particular traffic light during the time period.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational diagrammatic view illustrating an embodiment of the present invention;

FIG. 2 is a block diagrammatic view illustrating the preferred embodiment of the present invention; and

FIGS. 3A and 3B are flowcharts illustrating the operation of the preferred embodiment of the present invention.

### DETAILED DESCRIPTION OF A PREFERRED EMBODIMENT OF THE PRESENT INVENTION

With reference first to FIG. 17 an exemplary intersection 10 is illustrated having four corners 12, 14, 16 and 18 as well as a traffic light 20. In a conventional fashion, the traffic light includes a red light 22 representing a stop command, a yellow light 24 indicating a warning command and a green light 26 indicating a go command.

The traffic light 20 includes associated circuitry 28 which iteratively sends a wireless message msg as follows:
msg={redDuration, yellowDuration, greenDuration, currentPhase, timeToNextPhase, intersectionArea, txTime (transmission time)}
   where:
redDuration equals the duration in seconds of the red signal 22;
yellowDuration equals the duration in seconds of the yellow signal 24;
greenDuration equals the duration in seconds of the green signal 26;
currentPhase equals the current condition of the traffic light, i.e. red, green or yellow;
timeToNextPhase equals the time in seconds to the change from the current phase of the traffic light to the next phase of the traffic light;
intersectionArea equals the geographic position of the corners 12-18 of the intersection 14; and
txTime equals the current time at the traffic light when it transmitted the traffic light data.

The data msg transmitted by the traffic light 20 thus contains three different types of information. Specifically, the data redDuration, yellowDuration and greenDuration all relate to the operation of the particular traffic light 20. Different traffic lights will, of course, include durations for the red, yellow and green signals of different times.

Next, the data msg transmitted by the traffic light 20 contains information relating to the state of the traffic light at a particular time. This information includes the data currentPhase, timeToNextPhase and txTime for the traffic light transmitted data msg.

Lastly, the traffic light 20 generates the data message msg which contains information relating to the geographic area of the intersection 10. This information is included in the data intersection area of the transmitted message msg. Preferably, the data intersection area includes the longitudinal and lateral coordinates of the four corners 12, 14, 16 and 18 of the intersection 10. However, other types of data may be transmitted by the traffic light 20 to achieve the same purpose. For example, the longitude and latitude of one of the corners 12-18 of the intersection 10 may be transmitted along with data specifying the distance from that corner to the other corners of the intersection in order to define the geographic area of the intersection.

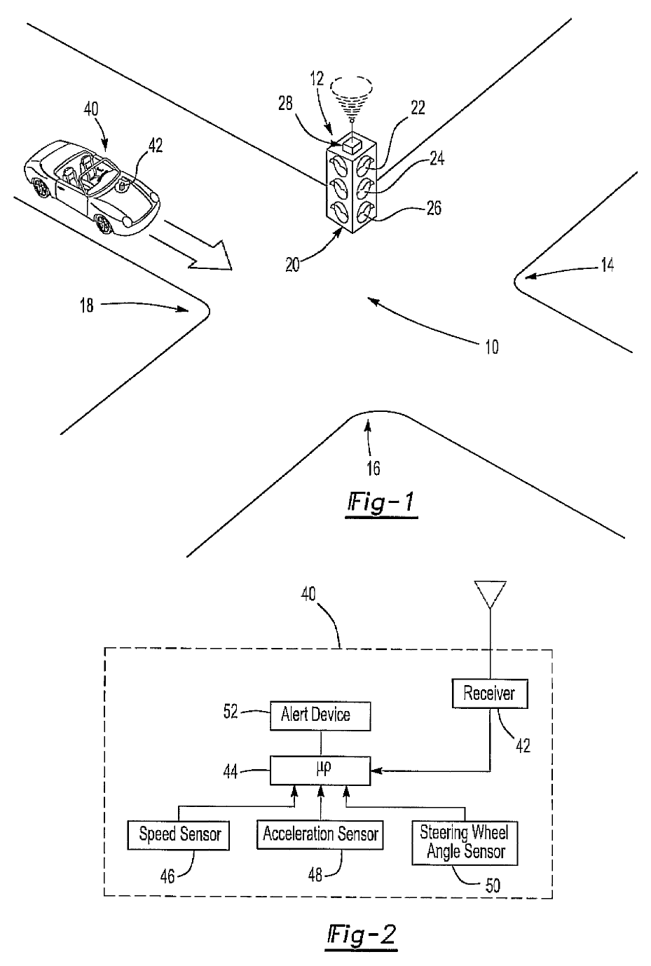

Still referring to FIG. 1, an automotive vehicle 40 approaching the intersection 10 contains a receiver 42 which receives the data msg transmitted wirelessly by the traffic light circuitry 28.

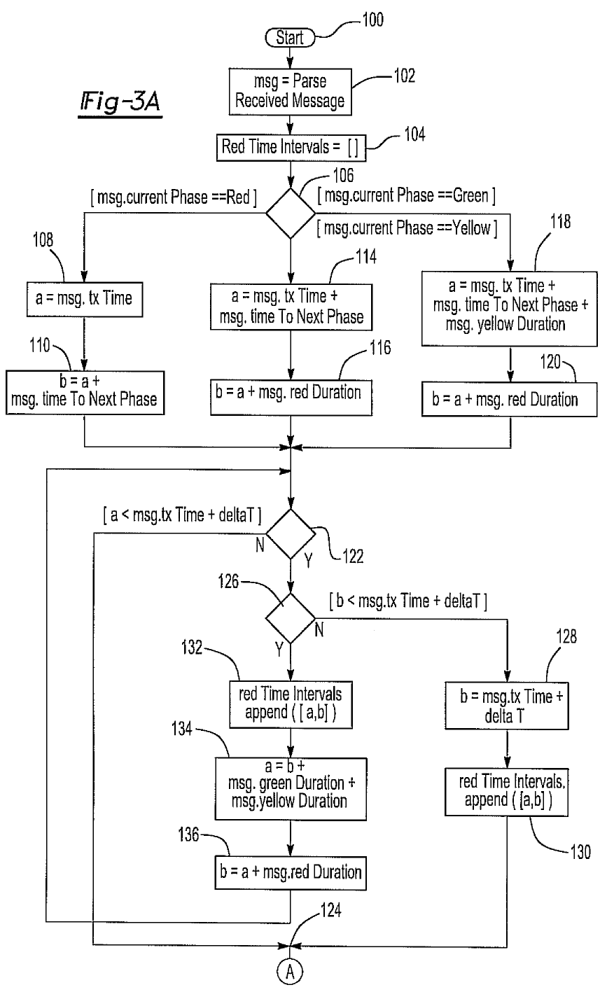

With reference now to FIG. 2, a block diagrammatic view of the processing circuitry contained in the vehicle 40 is shown for processing the data message msg transmitted by the traffic light 20. The circuitry includes a processor 44, typically a microprocessor, which receives the data message msg from the receiver 42 as an input signal. The processor 44 also receives inputs from various sensors indicative of the travel parameters of the vehicle. These sensors include, for example, a speed sensor 46 which produces an output signal to the processor 44 representative of the instantaneous speed of the vehicle 40, an acceleration sensor 48 which generates an output signal to the processor 44 representative of the acceleration/deceleration of the vehicle 40 as well as a steering wheel angle sensor 50 which provides an output signal to the processor 44 representative of the angle of the steering wheel. Other sensors can be included to improve the understanding of the current travel parameters of the vehicles. An alert device 52, such as an audible or optical signal, is also connected to the processor 44 as an output device.

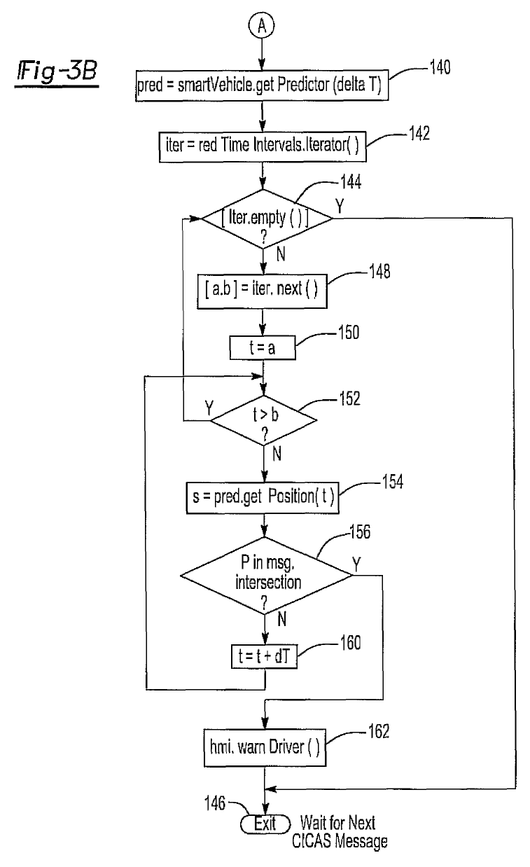

With reference now to FIG. 3, a flowchart illustrating the operation of the present invention is shown. The algorithm is initiated at step 100 which then proceeds to step 102. At step 102, the system receives the message msg from the traffic light 20 containing the information representative of the geographic area, state and operation of the traffic signal. Step 102 then proceeds to step 104.

At step 104, the system initializes the array redTimeIntervals to zero. The red time interval array will ultimately contain the time periods of red traffic signals about to be encountered by the vehicle 40. Step 104 then proceeds to step 106.

At step 106, a determination is made as to the current phase, at the time of transmission of the traffic light data, of the traffic light from the data msg.currentPhase. If the currentPhase is red, step 106 branches to step 108 and sets a variable a equal to msg.txTime, i.e. the time that the signal sent by from the traffic light. Step 108 then proceeds to step 110 and sets the variable b equal to a+msg.timeToNextPhase. Consequently, the variable a equals the time of the initiation of a red signal interval, in this case equal to the time the data was sent by the traffic light while b equals the time relative to the transmission time msg.txTime until the light changes to its next phase, i.e. green. Step 110 then branches to step 122.

Conversely, if the current phase of the stop light is yellow, step 106 instead branches to step 114 where the variable a, i.e. the initiation time of a red signal interval, is equal to the transmission time msg.txTime plus the time to the next phase msg.timeToNextPhase, i.e. a red light phase. Step 114 then proceeds to step 116 where the variable b, i.e. the termination time of the red signal interval, is set to the variable a plus the duration of the red light msg.redDuration. Step 116 then proceeds to step 122.

Lastly, if the current phase of the traffic light is green, step 106 instead branches to step 118 where the variable a is equal to the current time at the transmission from the traffic light msg.txTime plus the time to the next phase msg.timeToNextPhase plus the time of the yellow duration msg.yellowDuration. Thus the variable a equals the time of the initiation of a red signal interval. Step 118 then proceeds to step 120 where the variable b, i.e. the termination of the red signal, is set to the variable a plus the duration of the red light msg.redDuration. Step 120 then proceeds to step 122.

As a practical matter, only red lights occurring within a relatively short time period, e.g. ten seconds, from the transmission time msg.txTime are of interest to the vehicle. Consequently, at step 122 the variable a, i.e. the initiation time of the red signal interval, is compared to the transmission time msg.txTime plus a predetermined constant deltaT. If the initiation time of the red signal is greater than the transmission time plus the variable deltaT, indicative that the red light is not of interest to the vehicle, step 122 proceeds to step 124. Otherwise, step 122 proceeds to step 126.

At step 126, the variable b, i.e. the termination time of the red signal interval, is compared to the transmission time plus deltaT. If the termination time of the red signal interval is greater than the transmission time plus deltaT, step 126 branches to step 128 where the termination time of the red signal interval, b, is truncated to the transmission time msg.txTime plus deltaT. Step 128 is provided for convenience since events occurring later than the transmission time plus deltaT are not of interest to the vehicle. Step 128 then proceeds to step 130 in which the variables a and b, i.e. the initiation and termination times of the red signal interval, are stored in an array redTimeIntervals [ ] and step 130 proceeds to step 124.

In some situations it is possible that the signal will change to red more than once within the time of interest. In this case, the variable b, i.e. the termination time of the red signal interval, will be less than the transmission time plus deltaT and step 126 will branch to step 132. At step 132, the values a and b representing the initiation and termination times of the red signal interval are stored in the array redTimeIntervals and step 132 proceeds to step 134.

At step 134, the variable a is set to the next sequential activation of the red light by setting a equal to the previously determined variable b plus the duration of the green signal msg.greenDuration plus the duration of the yellow signal msg.yellowDuration. Step 134 then proceeds to step 136 where b is set to the now updated value for a plus the duration of the red light msg.redDuration. Step 136 then proceeds back to step 122 where the above process is repeated.

From the foregoing, it can be seen that steps 122-124 form an away redTimeIntervals [ ] of values where each element of the array contains the variable a equal to the time of the initiation of a red signal interval and the variable b equal to the termination time of the red signal interval. The array, however, will only contain information relating to the traffic signals that are of interest within a predetermined time period deltaT from the transmission time msg.txTime, e.g. ten seconds.

Step 124 then proceeds to step 140 where the position of the vehicle is projected or predicted at the time deltaT, i.e. the time interval of interest. Such a prediction would normally entail a smart vehicle having speed sensors, acceleration sensors, steering wheel angle sensors and a GPS system to identify the position of the vehicle. Additionally, any conventional mathematical routine may be utilized to predict the position of the vehicle at time deltaT from the current time such as by Kalman Prediction or through numerical integration of differential equation models. However, preferably the position of the vehicle is predicted at step 140 using numerical integration as described in U.S. patent application Ser. No. ______ entitled “Method and System for Predicting a Future Position of a Vehicle Using Numerical Integration” and naming Derek Caveney as the inventor which is herein incorporated by reference.

After the position of the vehicle is predicted at step 140, step 140 proceeds to step 142 where an array iteration tool iter for the red time interval array redTimeIntervals [ ] formed in steps 122-124 is established. Step 142 then proceeds to step 144 where it is determined if the array redTimeIntervals [ ] is empty, i.e. each red time interval contained in the array has been examined. If so, step 144 branches to step 146 and exits from the algorithm.

Conversely, assuming that the array redTimeIntervals [ ] contains at least one entry, step 144 instead branches to step 148 where the variables a and b, i.e. the initiation and termination times of the red signal interval, are retrieved from the array redTimeIntervals [ ]. Step 148 then proceeds to step 150 where a time variable t is set to a, i.e. the initiation time of the red signal interval. Step 150 then proceeds to step 152.

At step 152, the future time t is compared to the variable b, i.e. the termination of the red light signal. If the future time t is greater than the variable b, indicative that the red light has changed to a green light, step 152 branches back to step 144 and the above process is repeated. In this fashion, steps 144-152 continuously iterate through the entire array redTimeIntervals [ ].

Conversely, if the future time t is less than the termination of the red signal, step 152 instead branches to step 154 where the position p of the vehicle at the future time t is extracted from the prediction in step 140. Step 154 then proceeds to step 156 where the algorithm determines if the future position p is within the intersection area received from the traffic light. If so, step 156 branches to step 162 where a suitable output signal is provided to the alert device 52 (FIG. 2) and step 162 then exits the routine through step 146.

Conversely, if the position of the vehicle is not within the intersection during a red time interval at future time t, step 156 instead branches to step 160 where the future time t is incremented by a small time interval dT, e.g. a tenth of a second. Step 160 then branches back to step 152 where the above process is repeated until the future time t exceeds the variable b, i.e. the termination time of the red signal interval. Furthermore, it should be remembered that the time of the termination of the red signal b has a maximum value of the transmission time plus deltaT as set in step 128 where deltaT equals the time period of interest, e.g. ten seconds.

For example, assuming a time increment of dT equals one-tenth of a second and a time interval of interest for the warning system where deltaT equals ten seconds, the algorithm will iterate steps 152 to 160 a maximum of one hundred times, i.e. ten times per second for each of ten seconds.

From the foregoing, it can be seen that the present invention provides an effective traffic light warning system for a smart vehicle in which the system, after receiving the wireless communication from the traffic light, calculates and predicts whether or not the vehicle will be at the intersection during a red light time interval. If so, the appropriate warning device is activated to warn the driver to take the appropriate action, e.g. braking the vehicle.

Having described my invention, however, many modifications thereto will become apparent to those skilled in the art to which it pertains without deviation from the spirit of the invention as defined by the scope of the appended claims.

We claim:

1. A traffic light warning method for an automotive vehicle comprising the steps of:
receiving a signal from a traffic light representative of the geographic area, state and operation of the traffic light,
determining at least one time period in which the traffic light indicates a stop command,
predicting the position of the vehicle during said time period as a function of the position and travel parameters of the vehicle, and
generating a warning signal whenever the predicted position of the vehicle is within the geographic area of the traffic light during the time period.

2. The invention as defined in claim 1 wherein said stop command comprises a red light.

3. The invention as defined in claim 1 and comprising the steps of skipping said predicting and said generating steps whenever the initiation of said time period exceeds a threshold.

4. The invention as defined in claim 1 wherein said geographic area comprises the boundary of an intersection.

5. The invention as defined in claim 1 wherein the traffic light includes green, yellow and red lights and wherein said operation of said traffic light comprises the duration of the green, yellow and red lights of the traffic light.

6. The invention as defined in claim 1 wherein said determining step comprises determining a plurality of time periods wherein the initiation of each time period is less than a threshold.

7. The invention as defined in claim 1 wherein said signal receiving step comprises the step of receiving by wireless communication.

8. A traffic light warning system for an automotive vehicle comprising:
receiving a signal from a traffic light representative of the geographic area, state and operation of the traffic light,
means for determining at least one time period in which the traffic light indicates a stop command,
means for predicting the position of the vehicle during said time period as a function of the position and travel parameters of the vehicle, and
means for generating a warning signal whenever the predicted position of the vehicle is within the geographic area of the traffic light during the time period.

9. The invention as defined in claim 8 wherein said stop command comprises a red light.

10. The invention as defined in claim 8 wherein said geographic area comprises the boundary of an intersection.

11. The invention as defined in claim 8 wherein the traffic light includes green, yellow and red lights and wherein said operation of said traffic light comprises the duration of the green, yellow and red lights of the traffic light.

12. The invention as defined in claim 8 wherein said determining means comprises means for determining a plurality of time periods wherein the initiation of each time period is less than a threshold.

13. The invention as defined in claim 8 wherein said means for receiving comprises the means for receiving by wireless communication.

14. The invention as defined in claim 8 wherein said means for predicting comprises a processor programmed to estimate the position of the vehicle through numerical integration.
